(19) United States
(12) Patent Application Publication
(10) Pub. No.: US 2023/0169326 A1
(43) Pub. Date: Jun. 1, 2023

(54) METHOD AND APPARATUS FOR GENERATING PAIRED LOW RESOLUTION AND HIGH RESOLUTION IMAGES USING A GENERATIVE ADVERSARIAL NETWORK

(71) Applicant: KWAI INC., Palo Alto, CA (US)

(72) Inventors: Ahmed Cheikh SIDIYA, Palo Alto, CA (US); Xuan XU, Palo Alto, CA (US); Ning XU, Irvine, CA (US)

(73) Assignee: KWAI INC., Palo Alto, CA (US)

(21) Appl. No.: 17/539,172

(22) Filed: Nov. 30, 2021

(51) Int. Cl. G06N 3/08; G06N 3/04; G06T 3/40

(52) U.S. Cl. CPC G06N 3/08; G06N 3/0454; G06T 3/4046

(57) ABSTRACT

A method for training a neural network system for generating paired low resolution (LR) and high resolution (HR) images, the neural network system, an apparatus, and a non-transitory computer-readable storage medium thereof are provided. The method includes that a first generator in the neural network system generates a LR image based on a random vector; a second generator in the neural network system generates a HR image based on the random vector, where the HR image is paired with the LR image; obtaining a plurality of losses based on the LR image and the HR image; and updating the first generator based on the plurality of losses.

### FIELD

The present application generally relates to generating paired low resolution (LR) and high resolution (HR) images, and in particular but not limited to, generating the paired LR and HR images using a generative adversarial network (GAN).

### BACKGROUND

Two major factors necessary for most major deep learning methods include enough computing power and availability of large-scale dataset. The availability of large-scale dataset is essential when dealing with image restoration problems. Image restoration approaches are usually based on a supervised learning paradigm where the existence of important number of paired datasets including corrupted and uncorrupted images is necessary for convergence of model parameters. Traditional Image restoration methods usually apply artificial degradation to a clean and high-quality image to get the corresponding corrupted image. Bicubic down-sampling is used extensively in the case of single image super-resolution. However, these traditional methods exhibit grave limitations when tested on wild corrupted images.

### SUMMARY

The present disclosure describes examples of techniques relating to generating paired LR and HR images using a GAN.

According to a first aspect of the present disclosure, a method for training a GAN is provided. The method includes that: a first generator in the GAN generates a LR image based on a random vector; and a second generator generates a HR image based on the random vector, where the HR image is paired with the LR image. Furthermore, the method includes obtaining a plurality of losses based on the LR image and the HR image and updating the first generator based on the plurality of losses.

According to a second aspect of the present disclosure, an apparatus for training a GAN is provided. The apparatus includes one or more processors and a memory configured to store instructions executable by the one or more processors. Upon execution of the instructions, the one or more processors are configured to: generate a LR image based on a random vector by a first generator in the GAN; generate a HR image based on the random vector by a second generator, where the HR image is paired with the LR image; obtain a plurality of losses based on the LR image and the HR image; and update the first generator based on the plurality of losses.

According to a third aspect of the present disclosure, a non-transitory computer readable storage medium including instructions stored therein is provided. Upon execution of the instructions by one or more processors, the instructions cause the one or more processors to perform acts including: generating a LR image based on a random vector by a first generator in a GAN; generating a HR image based on the random vector by a second generator, where the HR image is paired with the LR image; obtaining a plurality of losses based on the LR image and the HR image; and updating the first generator based on the plurality of losses.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a block diagram illustrating a neural network system including an encoder with transformer blocks and a GAN prior network in accordance with one or more examples of the present disclosure.

FIG. 2 is a block diagram illustrating a neural network system for generating paired LR and HR images in accordance with one or more examples in the present disclosure.

FIG. 3 illustrates examples of paired LR and HR face images generated by the neural network system that is trained in accordance with one or more examples of the present disclosure.

FIG. 4 is a flowchart illustrating a method for training a neural network system implemented by one or more computers in accordance with one or more examples of the present disclosure.

FIG. 5 is a flowchart illustrating a method for training a neural network system implemented by one or more computers in accordance with one or more examples of the present disclosure.

FIG. 6 is a flowchart illustrating a method for training a neural network system implemented by one or more computers in accordance with one or more examples of the present disclosure.

FIG. 7 is a flowchart illustrating a method for training a neural network system implemented by one or more computers in accordance with one or more examples of the present disclosure.

FIG. 8 illustrates an apparatus for training a neural network system implemented by one or more computers in accordance with one or more examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g. devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may include steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The present disclosure provides a method for generating corrupted images from clean images. It can be classified as a neural style transfer method in which the style of real-world corrupted images is transferred to the clean images. In some examples in accordance with the present disclosure, human face images are used as examples and the present disclosure verifies that the degradation that is learned is very close to the one found in wild face images. Datasets may be used to train deep learning models to restore corrupted face images.

Four types of artificial degradation including Gaussian kernel, bicubic down-sampling, additive white noise, and JPEG compression may be used, sometimes separately and sometimes together, to corrupt clean images for the purpose of getting paired image datasets for deep learning model training.

Gaussian filter or kernel is a filter whose impulse response approximate a gaussian function. It is implemented by convolving an image with a gaussian function. It has the effect of blurring the image when applied. Bicubic down-sampling is an image interpolation method using the weighted average of neighboring pixels to determine the values in the resized image. Additive white gaussian noise (AWGN) is a popular noise that is added to a clean signal to simulate the effect of different random noise found in the wild. JPEG compression is a widely used lossy compression algorithm based on discrete cosine transform (DCT). All the four types of degradation are combined in the following order: first the high-resolution image is convolved with a gaussian filter and resized using the bicubic down-sampling operation; further, the gaussian noise is added and the result is compressed to get the degraded image corresponding to the high-resolution one. However, these methods suppose that the in-the-wild degradation can be modeled through a mathematical process, thus it is difficult to synthetic real-world image degradation kernel which is usually mixed by one or more degradations with various parameters.

CycleGAN is a form of style transfer which can add the style from one set of images to another and vice-versa. For example, stripes can be added to horses to create images of zebras using CycleGAN. CycleGAN consists of two deep neural networks, each of which is responsible for learning the mapping from one domain to the other. Both deep neural networks are trained using adversarial loss and a consistency loss. Encoded with the consistency loss, if an image is passed through both networks, the output should be the same as the original image.

However, CycleGAN is not specialized in face type images and its outputs lack the diversity needed to simulate the different types of face images degradation. In contrast, the present disclosure uses prior information found in a well-trained generative model to help increase the synthesized data diversity.

Furthermore, face image restoration methods that are trained on images degraded with gaussian blur kernel and bicubic down-sampling suffer from artifacts when tested on unseen real-world face data. And style transfer methods are not specialized in face image and suffer from lack of diversity in the generated data.

The present disclosure can generate a paired LR and HR face dataset that approximates real face image degradation found in the wild. In addition, the synthesized LR and HR dataset well approximates the diversity of degradation present in the real-world face data. Moreover, the present disclosure can generate unlimited face dataset for training.

In the present disclosure, synthetic data generation can be divided into two steps including collecting real-world low-resolution face data and training the style transfer type architecture to generate the paired noisy and clean image.

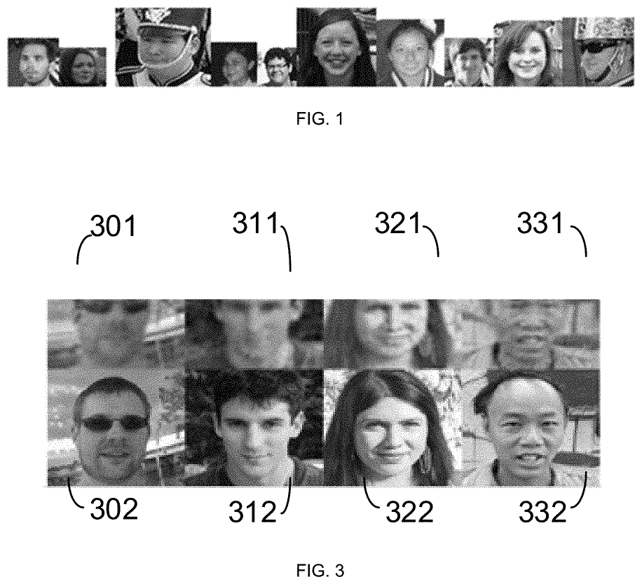

In order to collect images with the real-world degradation, the present disclosure crops the face region from RGB images present in the Wider Face Dataset. In some examples in accordance with the present disclosure, cropped region with face resolution lower than 64×64 or 128×128 is used. FIG. 1 shows an example of data collected by cropping face region from RGB images in accordance with one example of the present disclosure. The collected images in FIG. 1 are RGB images. The data collected from the real-world can be used to train the style transfer network.

A GAN may have two main neural networks including a generator and a discriminator. The generator learns to generate plausible data where the generated instances become negative training examples for the discriminator. The discriminator learns to distinguish the generator's data from real data. The StyleGAN is a continuation of the progressive, developing GAN that is a proposition for training generator models to synthesize enormous high-quality images via the incremental development of both discriminator and generator models. StyleGAN generally adopts the baseline progressive GAN architecture and suggests some modifications in the generator. In some examples, the generator in the GAN may be fed with randomized input that is sampled from a predefined latent space, e.g. a multivariate normal distribution. Thereafter, candidates synthesized by the generator are evaluated by the discriminator.

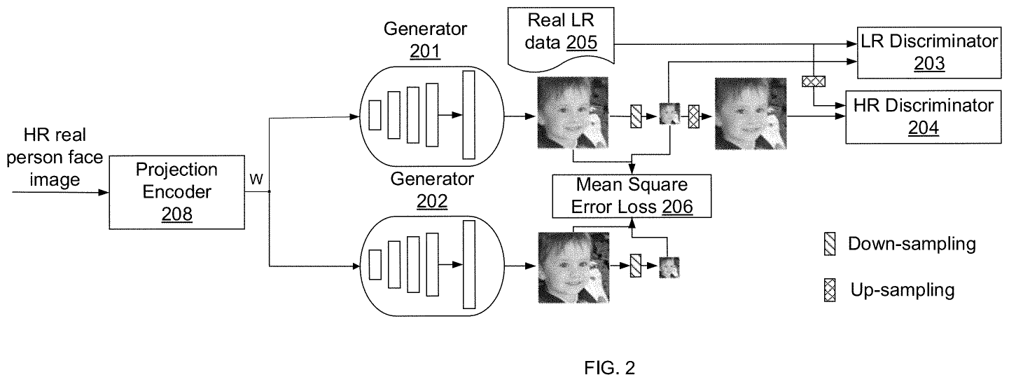

FIG. 2 is a block diagram illustrating a neural network system for generating paired LR and HR images in accordance with one or more examples in the present disclosure. The neural network system shown in FIG. 2 includes two generators including a first generator 201 and a second generator 202. In some examples, the two generators may be deep neural networks initialized with the pre-trained weights of StyleGAN and have the same architecture as a StyleGAN generator. The first generator 202, a LR discriminator 203, and a HR discriminator 204 may form a GAN structure.

In some examples, the second generator 202 may be a fixed generator that is responsible for generating HR face images. The second generator 202 applied weights of a generator in a pre-trained StyleGAN can directly generate HR face images without any training and the generated HR face image can guide the first generator 201 to generate the LR images which paired with the corresponding HR images.

The first generator 201 may be a trained generator that is responsible for generating degraded face images corresponding to the generated HR face images. The first generator 201 is updated using both pixel loss and adversarial loss. The pixel loss, e.g., a mean square error (MSE) loss, is responsible for making sure that the paired images are of the same subject and the adversarial loss pushes the distribution of the output of the trained generator, i.e., the first generator 201, closer to the distribution of the real-world wider data.

As shown in FIG. 2, an input W is fed into both the first generator 201 and the second generator 202. W may be a random vector and generated by sampling from random gaussian process. The first generator 201 generates a LR image based on W. The second generator 202 generates a HR image based on W. Down-sampling is applied to the LR image generated by the first generator 201 and a down-sampled LR image is obtained. Additionally, down-sampling is applied to the HR image generated by the second generator 202 and a down-sampled HR image is obtained. An MSE loss 206 may be obtained based on the LR image, the down-sampled LR image, the HR image, and the down-sampled HR image. The MSE loss is responsible for making sure that the LR image and the HR image are of the same subject.

Furthermore, an adversarial loss may be calculated by the LR discriminator 203 based on the down-sampled LR image and a sample LR real person image from real LR data 205. The LR discriminator 203 is responsible for pushing the output of the first generator 201 closer to the distribution of real world data.

Moreover, up-sampling may be applied to the down-sampled LR image and an up-sampled LR image may be obtained. Up-sampling may also apply to the LR real person image, and an up-sampled LR real person image may be obtained. Another adversarial loss may be then calculated by the HR discriminator 204 based on the up-sampled LR image and the up-sampled LR real person image. Similarly, the HR discriminator 204 is responsible for pushing the output of the first generator 201 closer to the distribution of real world data.

In some examples, the down-sampling may be bicubic down-sampling. For example, outputs of both the first generator 201 and the second generator 202 are of 1024×1024 resolution, and bicubic down-sampling is used to down-sample the outputs of the first generator 201 to 64×64.

In some examples, the up-sampling may be bicubic up-sampling. Bicubic up-sampling is used to up-sample the down-sampled LR image or the LR real person image from 64×64 to 1024×1024.

Once the neural network system shown in FIG. 2 is trained using the MSE loss and the two adversarial losses that are respectively generated by the LR discriminator 203 and the HR discriminator 204, the neural network system may be used to generate paired LR and HR image dataset. For example, the second generator 202 may generate high-quality face images and the first generator 201 may generate degraded face images corresponding to the high-quality face images. The neural network system may generate arbitrary number of paired images when random noise vector is inputted into the neural network system.

FIG. 3 illustrates examples of paired LR and HR face images generated by the neural network system that is trained in accordance with one or more examples of the present disclosure. The paired LR and HR face images may be RGB images. As shown in FIG. 3, the face images 301 and 302 are a pair of LR and HR face images, where the face image 301 is a LR image and the face image 302 is a HR image. The face images 311 and 312 are a pair of LR and HR face images, where the face image 311 is a LR image and the face image 312 is a HR image. The face images 321 and 322 are a pair of LR and HR face images, where the face image 321 is a LR image and the face image 322 is a HR image. The face images 331 and 332 are a pair of LR and HR face images, where the face image 331 is a LR image and the face image 332 is a HR image.

In some examples, a projection encoder network is added to the neural network system, which makes it possible to apply the learned degradation to a real HR face image because face image generated with StyleGAN may suffer from certain artifacts. As shown in FIG. 2, a projection encoder 208 is added. The projection encoder 208 receives one or more HR real person face images as inputs and outputs of the projection encoder 208 are used as random vectors W inputted to both the first generator 201 and the second generator 202. During testing phase, a real person HR face image can be projected into the latent space and the output passed through the trained StyleGAN based generator to get the corresponding degraded face images. Such neural network system with the projection encoder network added can also be trained end-to-end.

The present disclosure can automatically generate face dataset instead of manual face dataset collection and the synthesized LR data is closer to the real-world low-quality data. Moreover, though a random noise vector, unlimited number of face training data can be generated. Though style transfer network, the degradation found in real-world face data can be simulated.

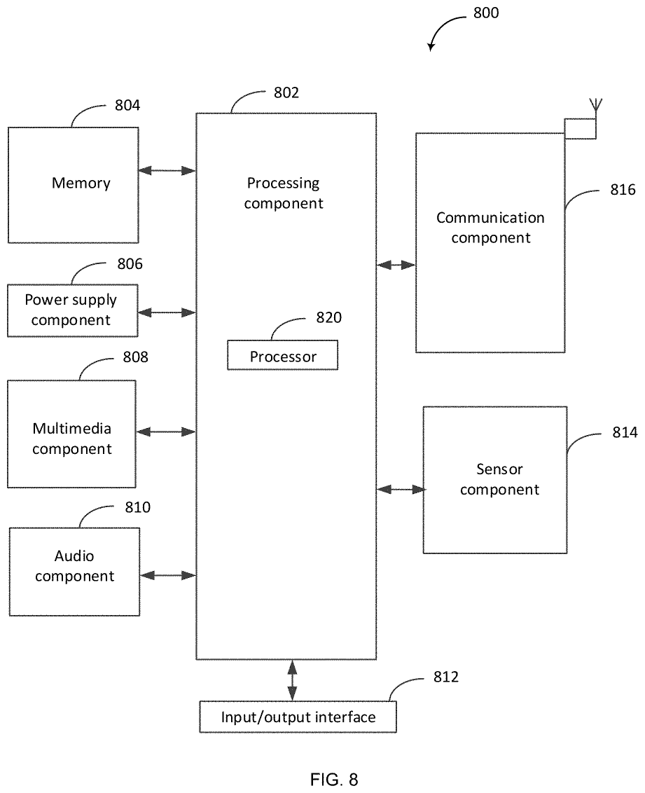

FIG. 8 is a block diagram illustrating an apparatus for training a GAN in accordance with one or more examples of the present disclosure. The system 800 may be a terminal, such as a mobile phone, a tablet computer, a digital broadcast terminal, a tablet device, or a personal digital assistant.

As shown in FIG. 8, the system 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operations of the system 800, such as operations relating to display, a telephone call, data communication, a camera operation, and a recording operation. The processing component 802 may include one or more processors 820 for executing instructions to complete all or a part of steps of the above method. The processors 820 may include CPU, GPU, DSP, or other processors. Further, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store different types of data to support operations of the system 800. Examples of such data include instructions, contact data, phonebook data, messages, pictures, videos, and so on for any application or method that operates on the system 800. The memory 804 may be implemented by any type of volatile or non-volatile storage devices or a combination thereof, and the memory 804 may be a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disk.

The power supply component 806 supplies power for different components of the system 800. The power supply component 806 may include a power supply management system, one or more power supplies, and other components associated with generating, managing, and distributing power for the system 800.

The multimedia component 808 includes a screen providing an output interface between the system 800 and a user. In some examples, the screen may include a Liquid Crystal Display (LCD) and a Touch Panel (TP). If the screen includes a touch panel, the screen may be implemented as a touch screen receiving an input signal from a user. The touch panel may include one or more touch sensors for sensing a touch, a slide and a gesture on the touch panel. The touch sensor may not only sense a boundary of a touching or sliding actions, but also detect duration and pressure related to the touching or sliding operation. In some examples, the multimedia component 808 may include a front camera and/or a rear camera. When the system 800 is in an operation mode, such as a shooting mode or a video mode, the front camera and/or the rear camera may receive external multimedia data.

The audio component 810 is configured to output and/or input an audio signal. For example, the audio component 810 includes a microphone (MIC). When the system 800 is in an operating mode, such as a call mode, a recording mode and a voice recognition mode, the microphone is configured to receive an external audio signal. The received audio signal may be further stored in the memory 804 or sent via the communication component 816. In some examples, the audio component 810 further includes a speaker for outputting an audio signal.

The I/O interface 812 provides an interface between the processing component 802 and a peripheral interface module. The above peripheral interface module may be a keyboard, a click wheel, a button, or the like. These buttons may include but not limited to, a home button, a volume button, a start button, and a lock button.

The sensor component 814 includes one or more sensors for providing a state assessment in different aspects for the system 800. For example, the sensor component 814 may detect an on/off state of the system 800 and relative locations of components. For example, the components are a display and a keypad of the system 800. The sensor component 814 may also detect a position change of the system 800 or a component of the system 800, presence or absence of a contact of a user on the system 800, an orientation or acceleration/deceleration of the system 800, and a temperature change of system 800. The sensor component 814 may include a proximity sensor configured to detect presence of a nearby object without any physical touch. The sensor component 814 may further include an optical sensor, such as a CMOS or CCD image sensor used in an imaging application. In some examples, the sensor component 814 may further include an acceleration sensor, a gyroscope sensor, a magnetic sensor, a pressure sensor, or a temperature sensor.

The communication component 816 is configured to facilitate wired or wireless communication between the system 800 and other devices. The system 800 may access a wireless network based on a communication standard, such as WiFi, 4G, or a combination thereof. In an example, the communication component 816 receives a broadcast signal or broadcast related information from an external broadcast management system via a broadcast channel. In an example, the communication component 816 may further include a Near Field Communication (NFC) module for promoting short-range communication. For example, the NFC module may be implemented based on Radio Frequency Identification (RFID) technology, infrared data association (IrDA) technology, Ultra-Wide Band (UWB) technology, Bluetooth (BT) technology and other technology.

In an example, the system 800 may be implemented by one or more of ASICs, Digital Signal Processors (DSPs), Digital Signal Processing Devices (DSPDs), Programmable Logic Devices (PLDs), FPGAs, controllers, microcontrollers, microprocessors, or other electronic elements to perform the above method.

A non-transitory computer readable storage medium may be, for example, a Hard Disk Drive (HDD), a Solid-State Drive (SSD), Flash memory, a Hybrid Drive or Solid-State Hybrid Drive (SSHD), a Read-Only Memory (ROM), a Compact Disc Read-Only Memory (CD-ROM), a magnetic tape, a floppy disk etc.

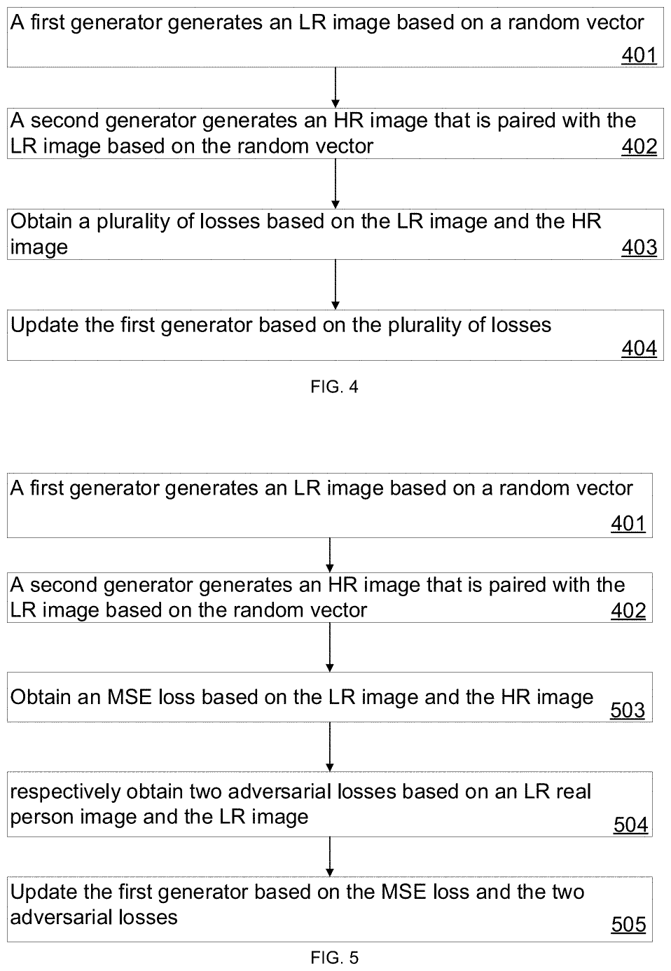

FIG. 4 is a flowchart illustrating a method for training a neural network system implemented by one or more computers in accordance with one or more examples of the present disclosure.

In step 401, a first generator in the neural network system generates a LR image based on a random vector. The neural network system may be the neural network system as illustrated in FIG. 2 and the first generator may be the first generator 301. The random vector may be the random vector W illustrated in FIG. 2.

In step 402, a second generator in the neural network system generates a HR image based on the random vector, where the HR image is paired with the LR image.

In some examples, the first generator may be a trained generator and the second generator may be a fixed generator. Both generators may each have same structure as a StyleGAN generator.

In step 403, a plurality of losses are obtained based on the LR image and the HR image.

In some examples, the plurality of losses may include an MSE loss and two adversarial losses. The MSE loss may be obtained based on the LR image and the HR image, as stated in step 503 in FIG. 5. The two adversarial losses may be respectively obtained based on a LR real person image and the LR image, as stated in step 504. The LR real person image may be from the real person LR data 205 as shown in FIG. 2. The first generator may be updated based on the MSE loss obtained in step 503 and the two adversarial losses obtained in step 504, as stated in step 505.

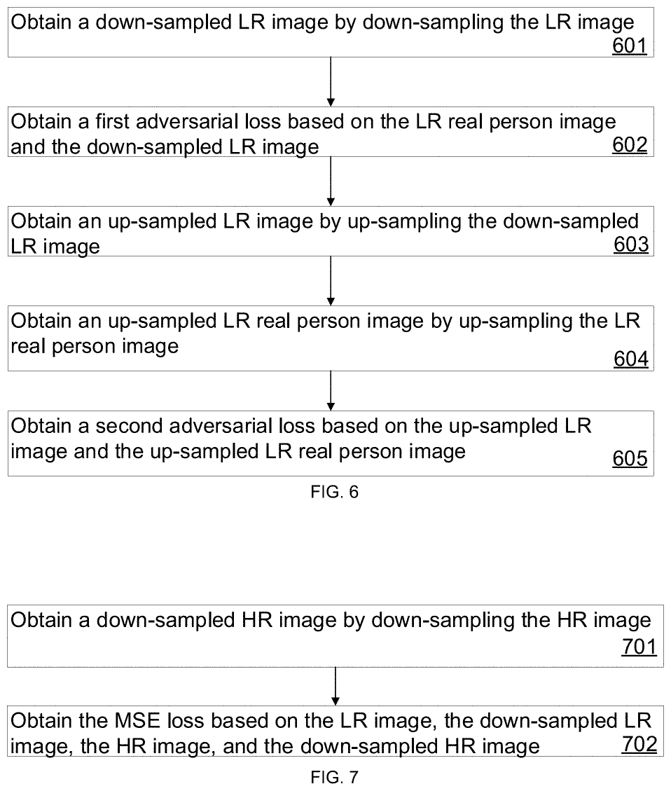

In some examples, a down-sampled LR image may be obtained by down-sampling the LR image, as stated in step 601 in FIG. 6. A first adversarial loss may be obtained based on the LR real person image and down-sampled LR image obtained in step 601. An up-sampled LR image may be obtained by up-sampling the down-sampled LR image, as stated in step 603. An up-sampled LR real person image may be obtained by up-sampling the LR real person image, as stated in step 604. As stated in step 605, a second adversarial loss may be obtained based on the up-sampled LR image obtained in step 603 and the up-sampled LR real person image obtained in step 604.

In some examples, a down-sampled HR image may be obtained by down-sampling the HR image obtained in step 402, as stated in step 701 in FIG. 7. Further, the MSE loss may be obtained based on the LR image, the down-sampled LR image, the HR image, and the down-sampled HR image, as stated in step 702.

In step 404, the first generator is updated based on the plurality of losses obtained in step 403.

In some examples, there is provided a non-transitory computer readable storage medium 804, having instructions stored therein. When the instructions are executed by one or more processors 820, the instructions cause the processor to perform methods as illustrated in FIGS. 4-7 and described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for training a generative adversarial network (GAN), comprising:
generating, by a first generator in the GAN, a low resolution (LR) image based on a random vector;
generating, by a second generator, a high resolution (HR) image based on the random vector, wherein the HR image is paired with the LR image;
obtaining a plurality of losses based on the LR image and the HR image; and
updating the first generator based on the plurality of losses.

2. The method of claim 1, wherein the plurality of losses comprise a mean square error (MSE) loss and two adversarial losses, and
wherein the method further comprises:
obtaining the MSE loss based on the LR image and the HR image; and
respectively obtaining the two adversarial losses based on an LR real person image and the LR image.

3. The method of claim 2, wherein the two adversarial losses comprise a first adversarial loss and a second adversarial loss, and
wherein the method further comprises:
obtaining a down-sampled LR image by down-sampling the LR image; and
obtaining the first adversarial loss based on the LR real person image and the down-sampled LR image.

4. The method of claim 3, further comprising:
obtaining an up-sampled LR image by up-sampling the down-sampled LR image;
obtaining an up-sampled LR real person image by up-sampling the LR real person image; and
obtaining the second adversarial loss based on the up-sampled LR image and the up-sampled LR real person image.

5. The method of claim 1, further comprising:
obtaining a down-sampled HR image by down-sampling the HR image; and
obtaining the MSE loss based on the LR image, the down-sampled LR image, the HR image, and the down-sampled HR image.

6. The method of claim 1, wherein weights of a generator in a pre-trained Style-based GAN (StyleGAN) are applied to the second generator.

7. The method of claim 1, wherein the LR image comprises an LR face image, the HR image comprises an HR face image, and the LR face image is a degraded face image paired with the HR face image.

8. The method of claim 1, further comprising:
obtaining, by a projection encoder, the random vector based on an HR real person face image.

9. The method of claim 1, wherein the first generator and the second generator are respectively a generator in a Style-based GAN (StyleGAN).

10. An apparatus for training a generative adversarial network (GAN), comprising:
one or more processors; and
a memory configured to store instructions executable by the one or more processors,
wherein the one or more processors, upon execution of the instructions, are configured to:
generate, by a first generator in the GAN, a low resolution (LR) image based on a random vector;
generate, by a second generator, a high resolution (HR) image based on the random vector, wherein the HR image is paired with the LR image;
obtain a plurality of losses based on the LR image and the HR image; and
update the first generator based on the plurality of losses.

11. The apparatus of claim 10, wherein the plurality of losses comprise a mean square error (MSE) loss and two adversarial losses, and
wherein the one or more processors are further configured to:
obtain the MSE loss based on the LR image and the HR image; and
respectively obtain the two adversarial losses based on an LR real person image and the LR image.

12. The apparatus of claim 11, wherein the two adversarial losses comprise a first adversarial loss and a second adversarial loss, and
wherein the one or more processors are further configured to:
obtain a down-sampled LR image by down-sampling the LR image; and
obtain the first adversarial loss based on the LR real person image and the down-sampled LR image.

13. The apparatus of claim 12, wherein the one or more processors are further configured to:
obtain an up-sampled LR image by up-sampling the down-sampled LR image;
obtain an up-sampled LR real person image by up-sampling the LR real person image; and
obtain the second adversarial loss based on the up-sampled LR image and the p-sampled LR real person image.

14. The apparatus of claim 10, wherein the one or more processors are further configured to:
obtain a down-sampled HR image by down-sampling the HR image; and
obtain the MSE loss based on the LR image, the down-sampled LR image, the HR image, and the down-sampled HR image.

15. The apparatus of claim 10, wherein weights of a generator in a pre-trained Style-based GAN (StyleGAN) are applied to the second generator.

16. The apparatus of claim 10, wherein the LR image comprises an LR face image, the HR image comprises an HR face image, and the LR face image is a degraded face image paired with the HR face image.

17. The apparatus of claim 10, wherein the one or more processors are further configured to:
obtain, by a projection encoder, the random vector based on an HR real person face image.

18. The apparatus of claim 10, wherein the first generator and the second generator are respectively a generator in a Style-based GAN (StyleGAN).

19. A non-transitory computer-readable storage medium storing computer-executable instructions that, when executed by one or more computer processors, causing the one or more computer processors to perform acts comprising:
generating, by a first generator in a generative adversarial network (GAN), a low resolution (LR) image based on a random vector;
generating, by a second generator, a high resolution (HR) image based on the random vector, wherein the HR image is paired with the LR image;
obtaining a plurality of losses based on the LR image and the HR image; and
updating the first generator based on the plurality of losses.

20. The non-transitory computer-readable storage medium of claim 19, wherein the plurality of losses comprise a mean square error (MSE) loss and two adversarial losses, and
wherein the one or more computer processors are caused to perform acts further comprising:
obtaining the MSE loss based on the LR image and the HR image; and
respectively obtaining the two adversarial losses based on an LR real person image and the LR image.
